(19) United States
(12) Patent Application Publication
(10) Pub. No.: US 2003/0123707 A1
(43) Pub. Date: Jul. 3, 2003

(54) Imaging-based distance measurement and three-dimensional profiling system

(76) Inventor: Seujeung P. Park, Cupertino, CA (US)

Correspondence Address: Seujeung Park, 7890 Fiesta Lane, Cupertino, CA, 95014, US

(21) Appl. No.: 10/039,954

(22) Filed: Dec. 31, 2001

(51) Int. Cl. G06K 9/00

(52) U.S. Cl. 382/106

(57) ABSTRACT

A method and apparatus for determining the distance of each pixel or a set of pixels in images acquired by cameras and thus imaging the three-dimensional profiles of objects in the images is described A source of illumination is projected through a mask of two-dimensional pattern onto the objects and images from predetermined and different view points are captured by a camera or cameras. A computer algorithm is used to identify a pixel or a set of pixels in each area of the pattern in each acquired image. The distance of the pixel or the set of pixels in the images is uniquely calculated by using the X, Y coordinates of the pixel or the set of pixels in the images of different view points and the positional relationship of the different view points. The three-dimensional profile of objects in the images is determined by collecting the distance information of each pixel or an area of pixels in the images.

### CROSS-REFERENCE TO RELATED APPLICATIONS

Not Applicable.

1. Background—Field of Invention

This invention relates in general to apparatus and method of determining the distance of a pixel or a set of pixels in the images acquired by a camera or cameras, thus determining the three-dimensional profile of an object or objects in the images.

2. Background—Description of Prior Art

There have been several different methods developed for the imaging-based distance measurement and three-dimensional profiling technology. These can be categorized as followings:

Laser Beam Triangulation Methods: These approaches direct a focused laser beam as a spot or a line onto the objects, and detect the reflected beam with a sensor at different angle. The triangulation calculation measures the distance of each focused area. These methods suffer from the requirement of a large number of measurement samples to determine the dimensions of the objects, thus taking a long time.

Structured Illumination Methods: These methods project precise bands of light onto the part of the objects and detect the deformations of bands in the image taken from a different view angle. The deviation of the bands from straight lines is correlated to the distance from a reference surface. These methods suffer from the erroneous results due to difficulty in interpretation of line pattern when there are surface discontinuities in objects. Also, these methods produce ambiguity in matching the reflected line pattern with the illuminated pattern due to widely different view angle of projection and detection.

Two Cameras Methods: These methods uses two cameras at different view points. It requires identification of certain common features in two images obtained from the two cameras, such as certain shape characteristics of objects in the images. Even though conceptually straightforward and inexpensive, it suffers from the heavy computational need for identification of shape characteristics and matching between images. When the objects lack distinguishable characteristics, such as corners, patterns, edges, etc, these methods result in ambiguous and inaccurate estimates.

Moire Interferometry Methods: These methods rely on the measurement of the optical phase shift of reflected light patterns to obtain dimensional data. Even though these methods can offer relatively accurate measurement, they are difficult to use and involves a number of exposures to attain the accuracy.

The following patents describe the various methods of three-dimensional imaging systems of prior arts.

U.S. Pat. No. 6,298,152 to Ooenoki et al, Oct. 2, 2001;

U.S. Pat. No. 6,262,803 to Hallerman et al, Jul. 17, 2001;

U.S. Pat. No. 6,252,623 to Lu et al, Jun. 26, 2001;

U.S. Pat. No. 6,144,453 to Hallerman et al, Nov. 7, 2000;

U.S. Pat. No. 6,118,540 to Roy et al, Sep. 12, 2000;

U.S. Pat. No. 6,064,757 to Beaty et al, May 16, 2000;

U.S. Pat. No. 5,930,383 to Netzer, Jul. 27, 1999;

U.S. Pat. No. 5,838,428 to Pipitone et al, Nov. 17, 1998;

U.S. Pat. No. 5,778,548 to Cerruti, Jul. 14, 1998;

U.S. Pat. No. 5,757,674 to Marugame, May 26, 1998;

U.S. Pat. No. 5,753,931 to Borchers et al, May 19, 1998;

U.S. Pat. No. 5,675,407 to Geng, Oct. 7, 1997;

U.S. Pat. No. 5,661,667 to Rueb et al, Aug. 26, 1997;

U.S. Pat. No. 5,646,733 to Bieman, Jul. 8, 1997;

U.S. Pat. No. 5,513,276 to Theodoracatos, Apr. 30, 1996;

U.S. Pat. No. 5,500,737 to Donaldson et al, Mar. 19, 1996;

U.S. Pat. No. 5,189,493 to Harding, Feb. 23, 1993;

U.S. Pat. No. 4,983,043 to Harding, Jan. 8, 1991;

U.S. Pat. No. 4,979,815 to Tsikos, Dec. 25, 1990;

U.S. Pat. No. 4,594,001 to DiMatteo et al, Jun. 10, 1986;

U.S. Pat. No. 4,532,723 to Kellie et al, Aug. 6, 1985;

Even though certain methods described above can have merits in certain field of applications, there exists a strong need for a general purpose imaging-based distance measurement and three-dimensional profiling method which has a broad range of applications, is accurate, inexpensive to manufacture, easy to operate, and does not involve heavy and complex computation needs. It is the motivation of present invention to develop such a system.

### SUMMARY

In accordance with the present invention, an imaging-based distance measurement and three-dimensional profiling system uses a two-dimensional pattern projection by illumination onto the objects in the imaging area and acquires images with the projected pattern from at least two predetermined and different view points. A computer program, which already knows specifically the details of the projected two-dimensional pattern, identifies a pixel or a set of pixels in each acquired image that corresponds to each section of the pattern. The identification of X, Y coordinates of the pixels in each section of the pattern in each of the images acquired from the different view points, taking into account the positional relationship of the view points, leads to calculation of the distances of those pixels.

Objects and Advantages

The principal objective of the present invention is to provide a general-purpose imaging-based distance measurement and three-dimensional profiling system which gives accurate results for a broad range of different application and situations. The situations can be where the objects in the images can be of any shape and surface colors, continuous or discontinuous object surfaces, in static or in motion, living or non-living. It is also an objective of the present invention to provide such a system which is simple to use, inexpensive to manufacture and operate, and relatively quick by not involving complex and heavy computational needs. The foregoing objectives have been accomplished by using illuminated projection of a priori known two-dimensional pattern onto the objects and acquiring at least two images from predetermined and different view points. Then, each section of the a priori known pattern is identified algorithmically in the acquired images and by considering the positional relationship of the view points of the images, the distance of each pixel or a set of pixels in each section of the patter is calculated.

The imaging-based distance measurement and three-dimensional profiling system in accordance with the preferred embodiments of the present invention uses two cameras for which the positional relationship is known. Both cameras face toward the objects, but they are aligned with a predetermined distance between them and each with a predetermined viewing angles. Thus, the two cameras have predetermined and different view points. Then, an illuminated projection unit is positioned in the vicinity of the two cameras. The unit projects a two-dimensional pattern onto the objects. A computer program, which already knows specifically the details of the two-dimensional pattern, identifies a pixel or a set of pixels in each acquired image which corresponds to each section of the pattern with great accuracy and without heavy computations. Then, due to the two different view points of the cameras, the position of the pixel or the set of pixels in one image is different from that of the other image. The difference in its position between the two images leads the program to calculate its distance. If a single camera is used, in accordance with another embodiment of the present invention, after acquiring an image, the camera needs to be moved to a different view point to acquire the second image, while the same patterned projection is made onto the objects.

The imaging-based distance measurement and three-dimensional profiling system of the present invention provides the benefits of both the conventional Two Cameras Methods and the Laser Beam Triangulation Methods. To the conventional Two Cameras Methods, it adds the ability of Laser Beam Triangulation Methods which allows the program to identify the laser-beamed spot and then accurately calculate its distance. However, instead of beaming a laser spot on each area of objects at a time, it uses a priori known two-dimensional pattern so that the computer program can identify each section of pattern in the images all at once. The identification and calculation by the computer program which knows a priori what to look for in the acquired images provide a great deal of advantages in accuracy, speed, simplicity, and in avoiding ambiguity. Thus, instead of looking for characteristics and features inherent in the shape or colors of objects in the images, which generally vary widely and unpredictably, the system of the present invention uses engineered patterns of characteristics and features projected on objects in image for spot identification purpose between images. Also, unlike the Laser Beam Triangulation Methods, the cameras and the projection unit do not have to be positioned at widely different angles. They can be positioned in relatively close vicinity of each other. These advantages allow the system of the present invention adoptable to a broad range of applications.

In summarizing the advantages, one of the most important advantages of the imaging-based distance measurement and three-dimensional profiling system of the present invention is its ability to be adopted to a broad range of applications. A number of additional advantages are also evident:

(a) It offers the precision of laser beam methods at a greatly reduced operating cost and with orders of magnitude greater speed by using projection of a priori known two-dimensional patterns on the objects in the images.

(b) Unlike the Laser Beam Triangulation Methods or Structured Illumination Methods, it does not require the precision and exactness in the relative location and angles of the projection and the camera. Also, it does not require the projection and the detection should have widely different viewing angle. The projection unit can be located in the vicinity of the cameras. The accuracy of the position and the viewing angle of the projection unit is not critical as long as it projects toward the objects in general.

(c) Relying on the identification of characteristics and features inherent in the objects in the images, as in the conventional Two Cameras Methods, involves a great deal of ambiguity, thus causing inaccuracy, and heavy computations, thus causing loss of speed. Since the system of the present invention uses the a priori known two-dimensional patterns which the computer program is instructed to look for and identify each area in the patterns, identification of a certain pixel or a certain set of pixels in the pattern across images is accurate and fast. This provides a considerable advantage over the conventional Two Cameras Methods.

(d) Since there is no strict hardware and precision requirements, it offers a great deal of flexibility in the selection of image detection devices and projection units. Also, the two-dimensional patterns can be customized to suit the needs of any specific application. Under an adverse lighting environment, the contrast of projected patterns can be enhanced by various approaches. For an example, the intensity of the projection can be adjusted to enhance the contrast of patterns. Also, the contrast of patterns detected from a view point can be enhanced by taking a differential of two images acquired under different conditions, such as; 1) the differential between images acquired from the same view point, but one with projection through the pattern mask and the other without the projection, 2) the differential between images acquired from the same view point with projections, but one with using the pattern mask and the other without pattern mask, etc.

(e) There can be practically infinite number of different designs of the two-dimensional patterns which can be used for the projection. The only sensible requirement of the pattern is the ease of uniquely identifying each area in the pattern by the computer program. Typically, a specific subsection in the pattern will be uniquely identified by the shape and/or color characteristics in that subsection area, or sometimes with the aid of those of neighboring subsections. This flexibility allows a customization of patterns using different shapes characteristics and features. Simple black and white patterns can be used, or patterns incorporating color characteristics can be used as needed, or even any selected band of light wavelength can be used as long as an image detector can acquire the image with the patterned projection. As long as the pattern is instructed to the computer program so that it knows what to look for in the acquired images, any customized pattern can be applied.

As will be evident by the ensuing description and drawings, the imaging-based distance measurement and three-dimensional profiling system of the present invention is simple to use to get fill advantage of its desired features. Still further objects and advantages of this invention will become apparent from a consideration of the drawings and ensuing description.

### DRAWING FIGURES

FIG. 1 describes an example of many possible designs of two-dimensional patterns used for the projection. FIG. 2 describes the imaging-based distance measurement and three-dimensional profiling system of the preferred embodiment. FIG. 3 describes an alternative embodiment.

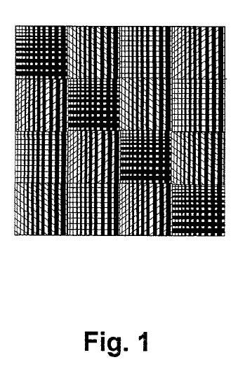

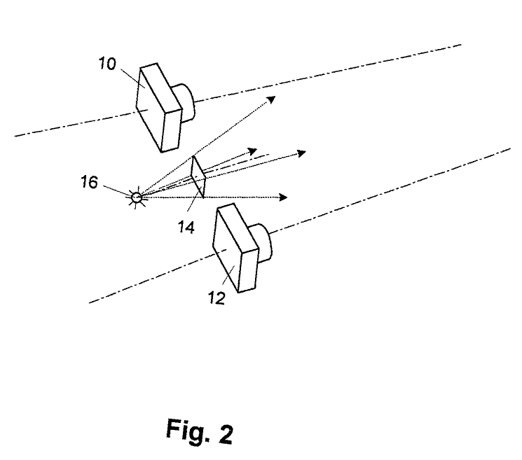

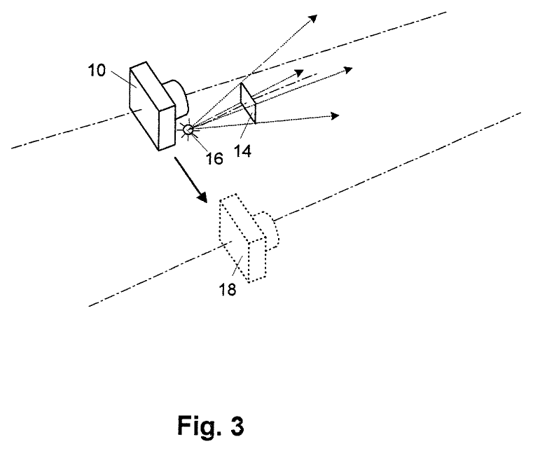

Refernce Numerals In Drawings

| | |
|---|---|
| 10 a camera | 12 another camera |
| 14 two-dimensional pattern mask | 16 source of illumination |
| 18 another position of the camera | |

### DESCRIPTION—FIG. 2—PREFERRED EMBODIMENT

A preferred embodiment of the imaging-based distance measurement and three-dimensional profiling system of the present invention is illustrated in FIG. 2. The system uses two cameras 10, 12, an illumination source 16, and a pattern mask 14 through which the illumination is projected.

The first camera 10 and the second camera 12 are positioned at predetermined and different view points, both facing toward the objects to be imaged. Thus, the positional relationship of the two cameras 10, 12 are known. The two cameras have a predetermined distance between them and each camera has a predetermined viewing angle relative to that of the other camera. This arrangement allows images of two different view points of the objects to be acquired by these cameras. A projection unit that consists of the source of illumination 16 and a two-dimensional pattern mask 14 is positioned in the vicinity of the cameras. The pattern mask 14 faces in the general direction toward the objects for which the images are acquired.

Operation of Invention—FIG. 2—Preferred Embodiment

To summarize the usage of the preferred embodiment of the present invention, the following procedure can be suggested. First, power on the source of illumination 16 so that the a priori known two dimensional pattern in the pattern mask 14 is projected onto the objects. Second, images of two different view points are acquired by both cameras 10, 12 simultaneously and fed to a computer program. The computer program is already instructed about the pattern used in the mask. The computer program looks for each section of the pattern in both images and identifies the corresponding pixel or set of pixels in each image. It measures the X,Y coordinates of the identified pixel or pixels in each image. The X, Y coordinate values in both images and the positional relationship of the cameras are used to calculate the distance of the pixel of pixels from the camera. Repeat the identification and calculation for different areas in the images until a sufficient amount of three-dimensional profiling information is obtained.

Depending on the lighting condition in the environment, the following variation in the aforementioned procedure can be used to obtain enhanced contrast of patterns. First, power on the source of illumination with no mask, or with a blank mask. Acquire two images under this condition by the two cameras. Second, power on the source of illumination with the patterned mask. Acquire two images under this condition by the two cameras. The two images acquired by the first camera are fed to a computer program which performs pixel-to-pixel differentials between the two images and generates the differential image with an enhanced pattern contrast. Repeat the same for the two images acquired by the second camera. The two differential images thus generated are used for the aforementioned pattern identification and the calculation of distances of a pixel or a set of pixels in each area of the images.

Depending on the lighting condition in the environment, the following further variation in the aforementioned procedure can be used to obtain enhanced contrast of patterns. Before powering on the source of illumination, acquire two images by the two cameras. Then, power on the source of illumination with the patterned mask. Acquire two images under this condition by the two cameras. The two images acquired by the first camera are fed to a computer program which performs pixel-to-pixel differentials between the two images and generates the differential image with an enhanced pattern contrast. Repeat the same for the two images acquired by the second camera. The two differential images thus generated are used for the aforementioned pattern identification and the calculation of distances of a pixel or a set of pixels in each area of the images.

FIG. 3—An Additional Embodiment

Additional embodiment is shown in FIG. 3; instead of using two cameras, one camera 10 is used to acquire the images from the two different view points. After acquiring the image from one predetermined view point, the camera is moved to the second predetermined view point 18 to acquire the image from that view point. The projection through patterned mask 14 by the source illumination 16 must be made while the image from each view point is acquired. The processing of images acquired from the two predetermined view points is same as that of the preferred embodiment.

As described in the preferred embodiment, depending on the lighting condition in the environment, a differential image can be used for enhanced pattern contrasts for each view point. The pixel-to-pixel differential can be made between the image acquired while projection through patterned mask is on and the image acquired without projection from the same view point. Or, the pixel-to-pixel differential can be made between the image acquired with projection through the patterned mask and the image acquired with projection without mask from the same view point. Still the same one camera can be used to acquire the four images, two images from each of two different view points, by repositioning the camera between the two predetermined view points.

Conclusion, Ramification, and Scope

Thus the reader will see that the imaging-based distance measurement and three-dimensional profiling system of this invention is novel, simple to operate, accurate, flexible, inexpensive to manufacture, efficient in processing speed, and has a broad range of applications.

While the above description contains many specificities, these should not be construed as limitation on the scope of the invention, but rather as an exemplification of one preferred embodiment thereof. Many other variations are possible. For example, the different types of detectors other than cameras can be used as long as they can detect the projected pattern of the illumination source selected. Any type of illumination source can be used to project the patterns onto the objects as long as it is detectable by the type of detectors selected. There can be many arrangements of the two view points, other than exhibited in the previous embodiment, as long as the it is taken into account in the calculation of the distance. Also, more than two view points can be used for better confidence of the distance calculation result. Further, multiple number of images can be acquired under an identical condition, from the same view point, for improved statistical accuracy for pattern identifications and distance calculations. For enhanced pattern contrasts in the image, any image processing other than the differential methods described in the previous embodiment can be employed as long as it offers enhanced pattern contrasts than the unprocessed images.

Accordingly, the scope of the invention should be determined not by the embodiments illustrated, but by the appended claims and their legal equivalents.

I claim:

1. An imaging-based distance measurement and three-dimensional profiling system comprising:
a) source of illumination,
b) mask of two-dimensional pattern through which said illumination is projected onto the objects,
c) means for acquiring images of said objects from predetermined and different view points, and
d) computer program for identifying each area in said two-dimensional pattern in said acquired images and calculating the distance of said each area using the identified coordinates of said each area in said acquired images and the positional relationship of said predetermined and different view points.

2. The imaging-based distance measurement and three-dimensional profiling system of claim 1 wherein said source of illumination is of any light wavelength or any combination of different wavelengths, of steady, pulsed, or flash operation.

3. The imaging-based distance measurement and three-dimensional profiling system of claim 1 wherein said source of illumination can use an optical filter or a set of optical filters for selecting a specific range of light wavelength.

4. The imaging-based distance measurement and three-dimensional profiling system of claim 1 wherein said mask of two-dimensional pattern is of a glass material, a plastic material, a film material, or any combination of these materials.

5. The imaging-based distance measurement and three-dimensional profiling system of claim 1 wherein said mask of two-dimensional pattern can be a composite of multiple mask layers to combine the patterns in each mask layer.

6. The imaging-based distance measurement and three-dimensional profiling system of claim 1 wherein said two-dimensional pattern is of black and white, transparent and opaque, gray-scale, or any combination of different colors.

7. The imaging-based distance measurement and three-dimensional profiling system of claim 1 wherein said means for acquiring images of said objects from predetermined and different view points can use two cameras, multitude of cameras, or a single camera.

8. The imaging-based distance measurement and three-dimensional profiling system of claim 1 wherein said means for acquiring images of said objects from predetermined and different view points includes digital cameras, CCD type cameras, video cameras or motion picture cameras.

9. The imaging-based distance measurement and three-dimensional profiling system of claim 1 wherein said means for acquiring images of said objects from predetermined and different view points can use an optical filter or a set of optical filters for selecting a specific range of light wavelength.

10. The imaging-based distance measurement and three-dimensional profiling system of claim 1 wherein said means for acquiring images of said objects from predetermined and different view points includes computer processing of images whereby said processed images have enhanced pattern contrasts.

11. The imaging-based distance measurement and three-dimensional profiling system of claim 10 wherein said computer processing of images includes pixel-to-pixel subtraction between two images acquired from a same view point, where one image is acquired when there is no projection and the other image is acquired when said illumination is projected through said mask of two-dimensional pattern.

12. The imaging-based distance measurement and three-dimensional profiling system of claim 10 wherein said computer processing of images includes pixel-to-pixel subtraction between two images acquired from a same view point, where one image is acquired when the illumination is projected with no mask and the other image acquired when the illumination is projected through said mask of two-dimensional pattern.

13. The imaging-based distance measurement and three-dimensional profiling system of claim 10 wherein said computer processing of images includes processings of plurality of images acquired from a same view point, where said images are acquired by using plurality of masks of different two-dimensional patterns.

14. The imaging-based distance measurement and three dimensional profiling system of claim 1 wherein said computer program for identifying each area in said two-dimensional pattern in said acquired images and calculating the distance of said each area can include the functionality of collecting the distance information of each pixel for all pixels in certain areas of the image or for all pixels in the image, whereby said computer program can obtain the three-dimensional profiles of objects in the image.
